(19) United States
(12) Patent Application Publication
(10) Pub. No.: US 2013/0182071 A1
(43) Pub. Date: Jul. 18, 2013

(54) 3D VIDEO IMAGE ENCODING APPARATUS, DECODING APPARATUS AND METHOD

(71) Applicant: Brian Edwards, Bridgend (GB)

(72) Inventor: Brian Edwards, Bridgend (GB)

(73) Assignees: SONY EUROPE LIMITED, WEYBRIDGE SURREY (GB); SONY CORPORATION, TOKYO (JP)

(21) Appl. No.: 13/823,377

(22) PCT Filed: Oct. 11, 2011
(86) PCT No.: PCT/GB11/51948

§ 371 Date: Mar. 14, 2013

(30) Foreign Application Priority Data
Nov. 12, 2010 (GB) 1019169.0
Dec. 10, 2010 (GB) 1020974.0

(51) Int. Cl. H04N 13/00

(52) U.S. Cl. CPC H04N 13/0048
USPC 348/43

(57) ABSTRACT

A 3D video image encoding apparatus includes a segmentation mechanism to partition a 3D video image sequence into two or more segments, each including one or more 3D video images, an image processor to identify an overall minimum apparent distance to an observer within each segment of the 3D video image sequence, a metadata generator to encode the overall minimum apparent distance for a respective segment within metadata associated with that segment, and an indication of length of time of the segment, and/or indication of time until the next segment. A 3D video image decoding apparatus includes a metadata parsing mechanism to parse metadata associated with respective of plural segments of 3D video, to decode from the metadata an overall minimum apparent distance to an observer for that respective segment and an indication of length of time of that segment and/or indication of time until a next segment.

### FIELD OF INVENTION

The present invention relates to a 3D video image encoding apparatus, decoding apparatus and method.

### BACKGROUND OF THE INVENTION

Three dimensional (3D) or stereoscopic television displays operate by presenting a stereoscopic video image to an observer. In practice, this stereoscopic image comprises a pair of images (a left and a right image) that are respectively presented to the left and right eyes of an observer. These left and right images have different viewpoints, and as a result corresponding image elements within the left and right images have different absolute positions within the left and right images.

The difference between these absolute positions is known as the disparity between the corresponding image elements, and due to the well known parallax effect, the apparent distance of a stereoscopic image element (comprising presentation of the left and right versions of the image element to the respective eyes of the observer) is a function of this disparity.

Hence in a typical stereoscopic TV image there will be a plurality of stereoscopic image elements having respective different disparities between left and right images, resulting in different apparent distances between these elements and the observer. This results in the perception of depth, as foreground objects will appear closer to the observer than background objects.

For a traditional non-stereoscopic television, when an observer wishes to interact with their television in a manner that requires additional information to be displayed, for example to display current programme details, an electronic program guide, a clock, subtitles, or a menu, a common approach is to superpose this additional information over the existing image. As such, the additional information is presented to appear in front of the existing program image.

To replicate this functionality on a 3D television, it is therefore necessary to generate, for superposition on to the existing left and right images of the stereoscopic program image, supplementary left and right images in which the additional information is positioned with a disparity that places the additional information as close or closer to the observer than the closest apparent stereoscopic image element in the stereoscopic program image. The disparity associated with the closest apparent stereoscopic image element in the stereoscopic program image may be termed the ‘minimum distance disparity’.

In many stereoscopic imaging technologies this will correspond to a maximum physical disparity between corresponding image elements in the left and right images of the stereoscopic image. However in the event that in a stereoscopic imaging technology this corresponds to a minimum physical disparity between corresponding image elements in the left and right images of the stereoscopic image, it will be appreciated that both arrangements are functionally equivalent to the minimum distance disparity for their respective technology.

Therefore, the disparity between positions of the additional information in the supplementary left and right images should equal or exceed the minimum distance disparity of the closest apparent stereoscopic image element in the stereoscopic program image in order to appear to be in front of the stereoscopic program image. In this case it will be understood that ‘exceed’ will mean ‘greater than’ where the minimum distance disparity is a maximum disparity in the stereoscopic program image, and will mean ‘less than’ where the minimum distance disparity is a minimum disparity in the stereoscopic program image.

However, if this approach was implemented on a frame-by-frame basis during presentation of a stereoscopic programme then it would cause the apparent distance of the additional information from the user to vary rapidly, making reading of the information difficult and likely to cause discomfort.

A solution to this problem is to identify a global minimum distance disparity over the course of a program (a so-called ‘event’) or a channel (a so-called service); in the latter case, a minimum distance disparity in transmitted stereoscopic images may be defined by a formal or de facto stereoscopic image standard adhered to by the service.

This global minimum distance disparity can be included in the Program Map Table (PMT) of a program transmission or in similar program/transmission descriptor metadata, such as Service Information (SI) and tables for such SI, or in any other suitable metadata associated with the 3D video. For simplicity of explanation but without limitation, the following description makes reference to PMT only.

Given this global minimum distance disparity, additional information can be presented so as to ensure that it appears at the front of a stereoscopic image in a similar manner to that noted previously herein.

However in this case, for a large proportion of the time there may as a result be a significant difference in apparent depth between displayed additional information and the contents of the stereoscopic program.

This situation is illustrated in FIG. 1, which shows a time history of the minimum distance disparity of a stereoscopic programme over a time T. During the course of the programme (denoted by the x-axis) the minimum distance disparity 10 (denoted by the y-axis) reaches a global minimum outside a period in which on-screen displays (OSDs) of additional information (marked OSD 1 and OSD 2 in FIG. 1) occur. As a result, when they are used there is a large difference in apparent depth between the OSDs of additional information and the content of the programme. This can look unnatural to the user and potentially cause eye strain by inducing frequent changes in eye focus for the user.

A solution to this second problem is to identify the overall minimum distance disparity within a shorter segment of an event or service. Such segments will typically be in the order of minutes long, but alternatively could correspond to shot boundaries or similar edit points where the minimum distance disparity is likely to change rapidly. The overall minimum distance disparity for each segment may be included within PMT data or other suitable program descriptor metadata.

This solution is illustrated in FIG. 2, where the axes are the same as those of FIG. 1. It can be seen that in the example of FIG. 2, an event has been partitioned into four segments, and the overall minimum distance disparity for each segment has been included in PMT data PMTb 1-4. In each segment, the use of an OSD to display additional information results in the supplementary left and right images using a disparity that equals or exceeds the overall minimum distance disparity for that segment, meaning that the OSD depth placement better fits the currently displayed program.

However, this solution gives rise to a third problem as illustrated in FIG. 3. In FIG. 3, the axes and similarly labelled features are the same as in FIG. 2. In this case, it will be appreciated that the use of an on screen display is not constrained to the segment boundaries used by the event. Consequently an OSD whose depth placement is set in response to the overall minimum distance disparity of a first segment may persist into a second segment, where its apparent depth is no longer suitable. FIG. 3 illustrates scenarios in which the OSD becomes too far in front of the stereoscopic program image, and conversely in which the OSD ends up behind at least the closest image element of the stereoscopic program image.

The present invention aims to reduce or mitigate this problem.

### SUMMARY OF INVENTION

In a first aspect of the present invention, a 3D video image encoding apparatus is provided in claim 1.

In another aspect of the present invention, a 3D video image encoding apparatus is provided in claim 2.

In another aspect of the present invention, a 3D video image decoding apparatus is provided in claim 11.

In another aspect of the present invention, a 3D video image decoding apparatus is provided in claim 12.

In another aspect of the present invention, a method of 3D video image encoding is provided in claim 23.

In another aspect of the present invention, a method of 3D video image encoding is provided in claim 24.

In another aspect of the present invention, a method of 3D video image decoding is provided in claim 27.

In another aspect of the present invention, a method of 3D video image decoding is provided in claim 28.

Further respective aspects and features of the invention are defined in the appended claims.

### BRIEF DESCRIPTION OF DRAWINGS

Embodiments of the present invention will now be described by way of example with reference to the accompanying drawings, in which:

FIG. 1 is a schematic diagram of minimum distance disparity over the course of an event with static OSD disparity;

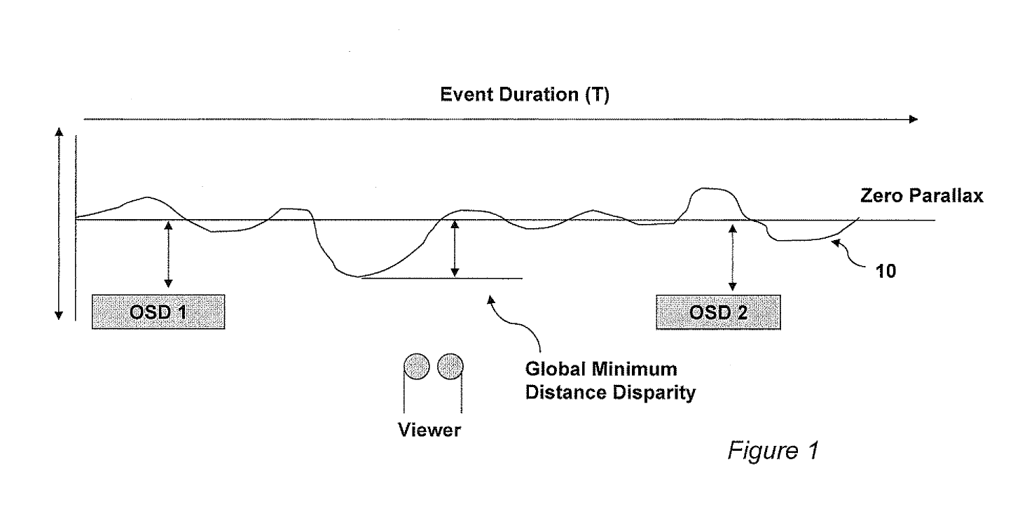

FIG. 2 is a schematic diagram of minimum distance disparity over the course of an event with dynamic OSD disparity;

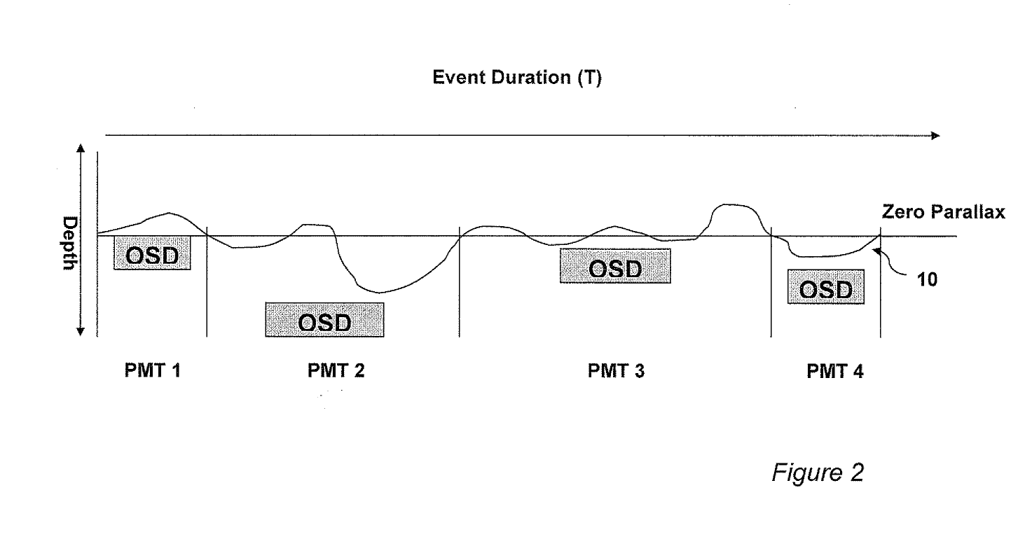

FIG. 3 is a schematic diagram of minimum distance disparity over the course of an event with dynamic OSD disparity illustrating a problem with OSD placement;

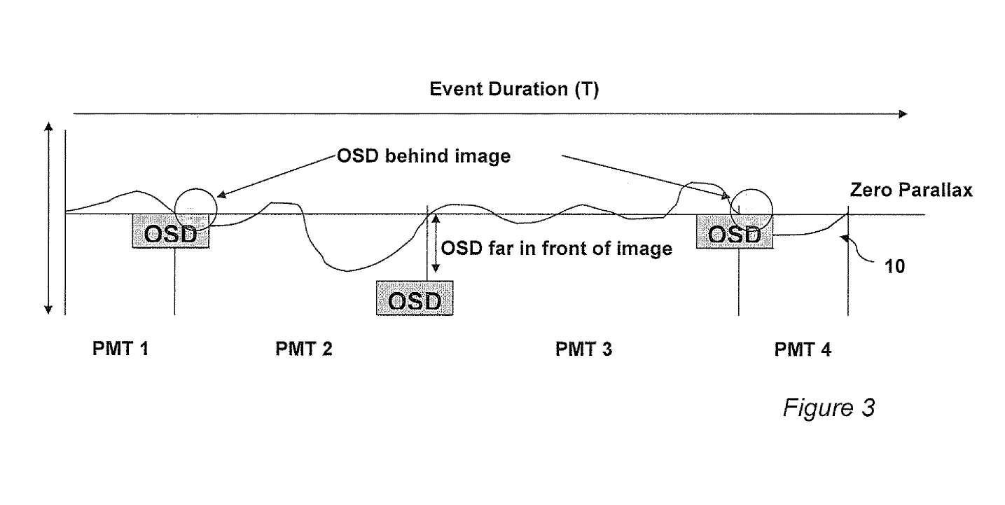

FIG. 4 is a schematic diagram of minimum distance disparity over the course of an event illustrating OSD disparity in accordance with an embodiment of the present invention;

FIG. 5 is a schematic diagram of minimum distance disparity over the course of an event illustrating OSD disparity in accordance with an embodiment of the present invention;

FIG. 6 is a schematic diagram of minimum distance disparity over the course of an event illustrating OSD disparity in accordance with an embodiment of the present invention;

FIG. 7 is a schematic diagram of a 3D video image encoding apparatus in accordance with an embodiment of the present invention;

FIG. 8 is a schematic diagram of a 3D video image decoding apparatus in accordance with an embodiment of the present invention;

FIG. 9 is a flow diagram of a method of 3D video image encoding in accordance with an embodiment of the present invention; and

FIG. 10 is a flow diagram of a method of 3D video image decoding in accordance with an embodiment of the present invention.

FIG. 11 is a schematic diagram of segment synchronisation to a video packetised elementary stream based upon presentation time stamps in a video depth descriptor packetised elementary stream, in accordance with an embodiment of the present invention.

### DESCRIPTION OF EXAMPLE EMBODIMENTS

A 3D video image encoding apparatus, decoding apparatus and method are disclosed. In the following description, a number of specific details are presented in order to provide a thorough understanding of the embodiments of the present invention. It will be apparent, however, to a person skilled in the art that these specific details need not be employed to practise the present invention. Conversely, specific details known to the person skilled in the art are omitted for the purposes of clarity where appropriate.

In an embodiment of the present invention, the metadata associated with each segment of the event (i.e. with the 3D video) is augmented with data indicating the length of the segment, or alternatively or in addition the time until the next segment boundary (i.e. when the next segment begins).

This enables a receiver of the 3D video, including the metadata to select when generating an OSD whether to use the overall minimum distance disparity for that segment, depending on an indication of when the segment will end and the next segment (having a different overall minimum distance disparity) begins.

The indication may be calculated based on the length of the segment and the current position of the displayed 3D video within that segment, or may be based on the indicated time to the next segment boundary.

Thus, taking a non-limiting example, if a user requests an action that results in the generation of an OSD more than 30 seconds before the next segment boundary, then the OSD would be generated using a left-right image disparity equal to or exceeding the overall minimum distance disparity of the current segment. However if a user requested an action that resulted in the generation of a OSD within less than a 30 second time threshold before the next segment boundary, it can be assumed that the OSD will persist beyond the boundary and so a different left-right image disparity may be used, such as a global minimum distance disparity for the current service. This avoids the risk of the OSD appearing to lie behind elements of the 3D video.

It will be appreciated that the time threshold may be empirically determined, and may be different for different types of additional information displayed by an OSD. For example the threshold for display of an electronic programme guide may be considerably longer than that for an on screen clock or volume control. The time threshold may thus be understood to mark the start of a transitional period during which the current minimum distance disparity is no longer used for new instances of OSDs. A flag, such as a so-called ‘disparity_change_notify’ flag, can be used to indicate the transitional period.

In an embodiment of the present invention, the metadata associated with each segment of the event is also augmented with data indicating the overall, minimum distance disparity of the immediately subsequent segment. Consequently a receiver of the 3D video can now select whether to use the overall minimum distance disparity of the current or immediately subsequent segment when generating an OSD, again based on the indicated time to the next segment boundary.

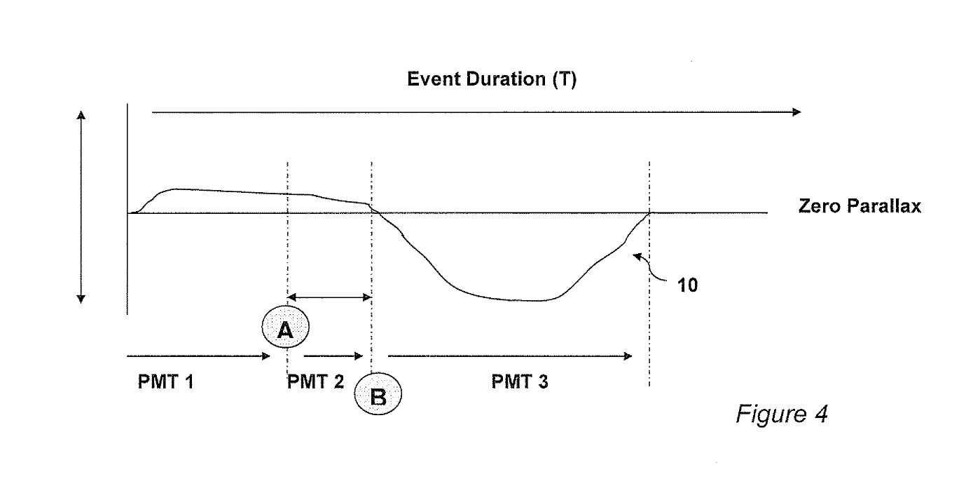

Referring to FIG. 4 in which again similar axes and features correspond to preceding Figures, in an embodiment of the present invention transitional segments are included between longer segments. These transitional segments are typically the same length or shorter than the time thresholds discussed above.

In FIG. 4, metadata for the segment associated with PMT1 is received and can be used as described herein. However, at point ‘A’, metadata for the segment associated with. PMT2 is received and a disparity_change_notify flag is set (i.e. indicating that the overall minimum distance disparity is going to change with PMT3). At point ‘B’, metadata for the segment associated with PMT3 is received and the disparity_change_notify flag is reset or cleared. In this case the PMT2 segment acts as a transitional segment between PMT1 and PMT3. During PMT2, time thresholds used by the receiver may be shortened, or alternatively any instigation of an OSD during the PMT2 segment uses the overall minimum distance disparity of the PMT3 segment by default.

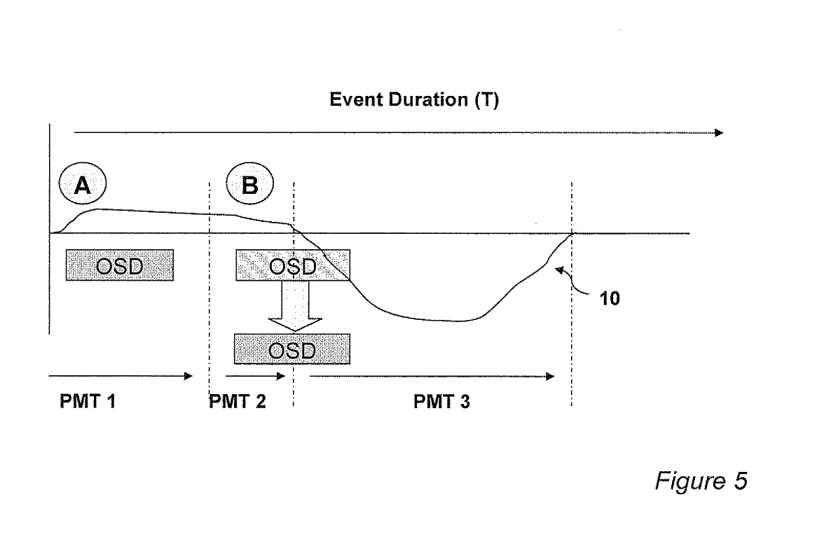

Referring now to FIG. 5, an illustration of features of the above embodiments is shown. In this case, PMT 2 may equally be a regular segment or a transitional segment. Again similar axes and features correspond to preceding Figures. In a first instance A, a user or the system triggers an action that results in the generation of a first OSD. The first OSD is triggered at a time sufficiently before the next segment boundary that the overall minimum distance disparity for the current segment (PMT 1 segment) is used. In a second instance B, the user or system triggers an action that results in the generation of a second OSD. The second OSD is triggered during segment PMT 2 at a time less than a threshold time until the next segment boundary (or alternatively if PMT2 is marked as a transitional segment), and so uses the overall minimum distance disparity for the PMT 3 segment, as found in the PMT 2 metadata, rather than the overall minimum distance disparity for the PMT 2 segment itself. In this case this prevents the OSD from appearing to be located behind one or more image elements of the 3D video.

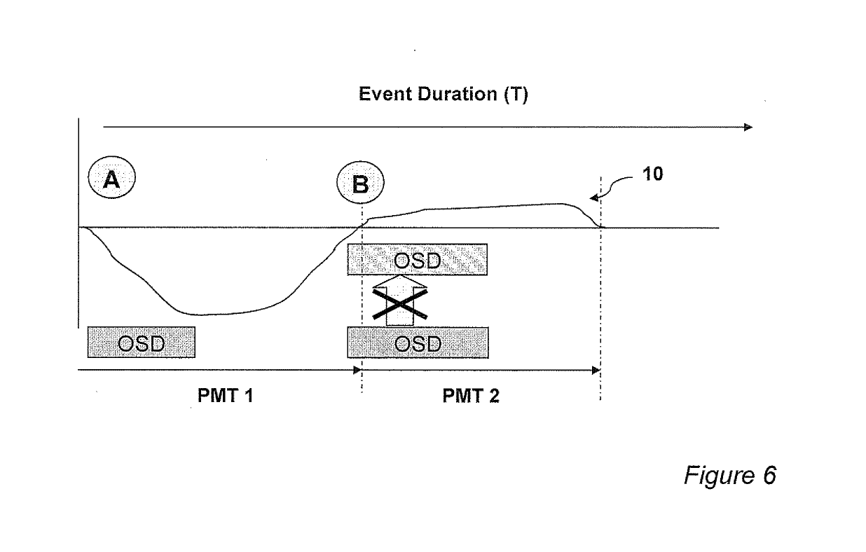

Referring now to FIG. 6 again with similar axes and features corresponding to preceding Figures, conversely where the overall minimum distance disparity for a current segment (e.g. PMT 1) corresponds to a closer overall apparent distance to the observer than for the next segment PMT 2, then optionally the current overall minimum distance disparity is retained in order to provide continuity of distance of OSDs. It will be appreciated that a designer of the system can decide whether the resulting apparent depth difference between the OSD and the content of the next segment is more important that continuity, for example by setting a threshold difference between the apparent distance of the OSD and the overall minimum apparent distance in the next segment, only preserving continuity of OSD difference if the difference was below a threshold. Similarly, the continuity may only be preserved if an OSD at the current apparent distance was previously displayed within a threshold time prior to display of the current OSD.

It will be appreciated that whilst the present description refers to PMT metadata, the timing data and minimum distance disparity data described herein may be located in any suitable metadata container associated with the 3D video—for example packetised elementary stream (PBS) metadata such as the pespacket_databyte_field. Moreover, the data may be located in multiple metadata containers, either as redundant copies (e.g. within both PMT and PES metadata) or by distributing different elements of the data over different containers.

It will also be appreciated that whilst the present description refers to a minimum distance disparity for images in a segment, in principle this data can be generated for sub-regions of images. For example, minimum distance disparity values for the whole 3D video image, or for halves, quarters, eighths or sixteenths of the image may be envisaged. Greater subdivision of the images in this way provides greater responsiveness in the depth positioning of OSDs where these occupy only a portion of the screen. In this case, it will be understood that the same methods as described herein apply in parallel for each sub-region of the image.

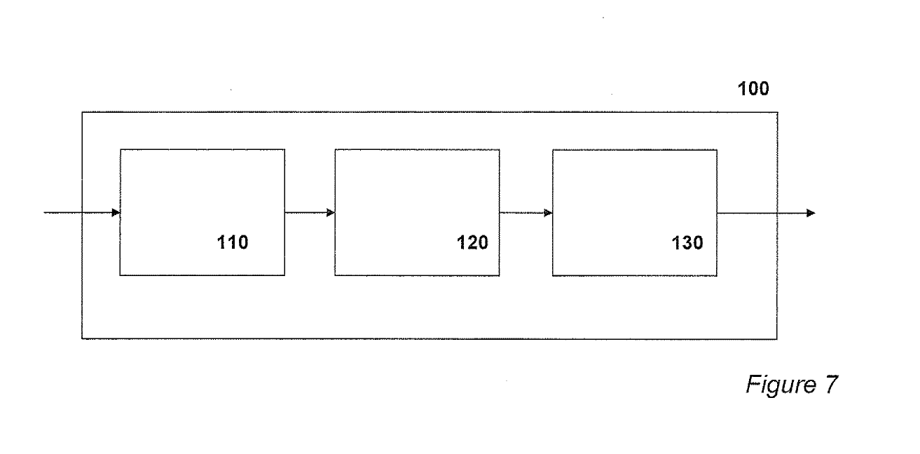

Referring now to FIG. 7, an embodiment of a 3D video image encoding apparatus 100 operable to implement features of the above embodiments comprises a segmentation means or a segmenter 110 operable to partition an input 3D video image sequence into two or more segments, each comprising one or more 3D video images.

In an embodiment of the present invention, the segmentation means synchronises the start and end points of segments with presentation time stamps (PTSs) associated with the video (e.g. the video PES data), and optionally similarly synchronises the time threshold beyond which the current segment's minimum distance disparity data is not used.

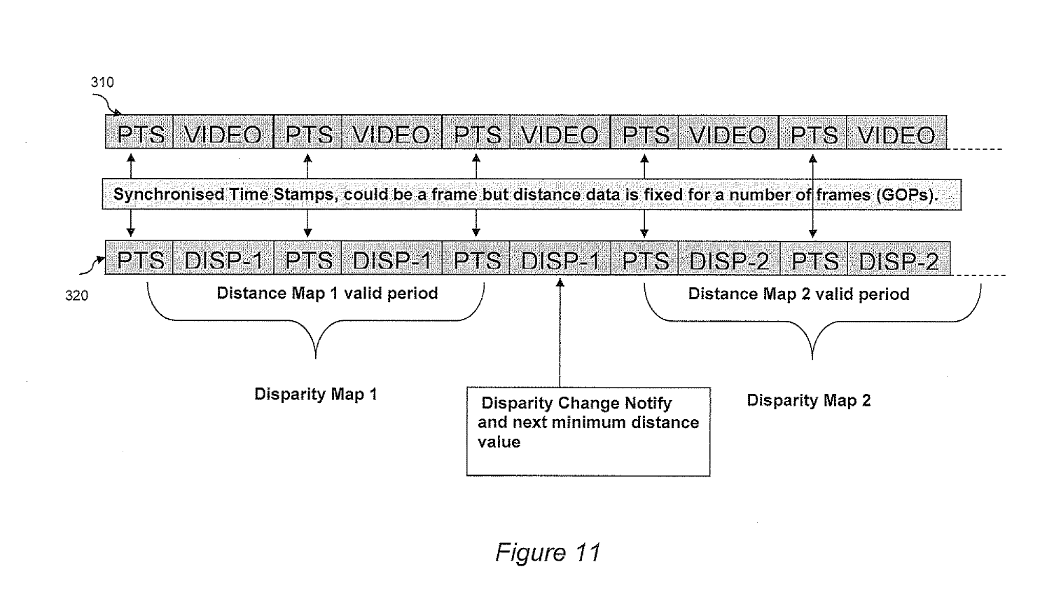

Referring to FIG. 11, in an embodiment of the present invention the timing and minimum distance disparity data is contained in metadata of a PES 320 separate to the video PES 310, such as a dedicated video depth descriptor PES. Such a PES 320 also contains PTSs, and synchronisation between segments and the video is based upon synchronising their respective PTSs. It will be appreciated that not every corresponding PTS needs to be synchronised or checked for synchronicity, however those relating to the start and end of segments and optionally the onset of the time threshold beyond which the next segment's minimum distance disparity data are synchronised. As a non-limiting example, a segment may align with synchronised with PTSs 1 and 150 in a numbered sequence of PTSs, whilst the disparity_change_notify flag is set at PTS 120.

It will be appreciated that in this embodiment the timing and minimum distance disparity data may still also be contained in the Video PES 310 and/or the PMT data to provide support for decoding systems that do not support or parse the separate PES.

Note that in FIG. 11, as a non-limiting example the minimum distance disparity data is illustrated as a distance map or disparity map (i.e. representing minimum distance disparity data for a plurality of image sub-regions as described herein).

In an alternative embodiment however, the segmentation means does not perform any such synchronisation.

The apparatus also comprises an image processing means or an image processor 120 operable to identify a value corresponding to an overall minimum apparent distance to an observer within each segment of the 3D video image sequence. In embodiments of the present invention, this value is the left-right disparity between the corresponding image elements having the minimum apparent distance to an observer with in a segment, as this provides a simple way to set the disparity for OSDs, but it will be appreciated that in principle any value that enables the disparity corresponding to the overall minimum apparent distance to the observer to be calculated is suitable. An example method of calculation is to perform lateral cross-correlation of the images in the stereoscopic image pair and note the largest valid offset between correlating features. As noted above, in embodiments of the present invention the image processor may similarly identify such values for corresponding sub-regions of the images in a segment.

The apparatus further comprises metadata generation means or a metadata generator 130 operable to encode the value corresponding to the overall minimum apparent distance for images or each of a set of sub-regions of images in a respective segment within metadata associated with that segment. It will be understood that the metadata generator may generate metadata to add to an existing metadata structure such as PMT or PES, or generate the structure itself, and that herein the term ‘encoding’ encompasses simply placing generated metadata appropriately within a metadata structure. The metadata generator 130 is also operable to encode an indication of the length of time of the segment, and/or encode an indication of the time until the next segment.

In an embodiment of the 3D video image encoding apparatus 100, the metadata generation means is also operable to encode within metadata associated with a first segment the value corresponding to the overall minimum apparent distance (or a set of such values) for an immediately subsequent segment as described previously herein.

It will be appreciated that the 3D video image encoding apparatus 100 may be incorporated within one or more of several devices and systems on the production or transmission side of an event or service. For example, a stereoscopic video camera comprising the 3D video image encoding apparatus 100 may analyse captured images and generate metadata as described herein for segments corresponding to shot boundaries. Likewise, an editing system comprising the 3D video image encoding apparatus 100 may analyse 3D video images and generate metadata as described herein for segments corresponding to edit points and/or separately denoted segments either generated automatically (for example by analysis of a deviation from a rolling average minimum distance disparity, triggering a segment when the deviation exceeds a threshold) or by an editor. Similarly a recording system for recording 3D video on physical media comprising the 3D video image encoding apparatus 100 may analyse 3D video images and generate metadata as described herein for segments of the recorded media for example using the above automated technique. Similarly a transmission system comprising the 3D video image encoding apparatus 100, may incorporate metadata based on an analysis of the 3D video images into the transmitted data, which may be transmitted terrestrially by wireless or cable, or transmitted by satellite, or transmitted over the internet.

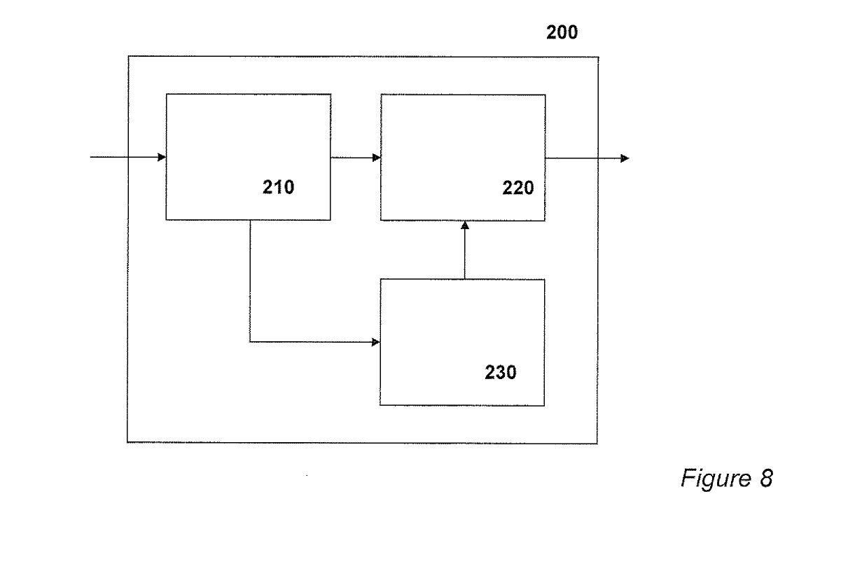

Referring now to FIG. 8 an embodiment of a 3D video image decoding apparatus 200 comprises a metadata parsing means or a metadata parser 210 operable to parse metadata associated with a respective one of a plurality of segments of 3D video, each segment comprising one or more 3D video images, the metadata parsing means being operable to decode from the metadata a value corresponding to an overall minimum apparent distance to an observer for images in that respective segment, or as noted above for each of a plurality of sub-regions of images in that segment. It will be understood that the term ‘decoding’ in this case encompasses simply extracting the value from a metadata structure.

The metadata parsing means is also operable to decode an indication of the length of time of that segment, and/or an indication of the time until a next segment, depending on the content of the received metadata.

In embodiments of the present invention, the metadata parsing means decodes data from one or more containers, such as in PMT data, Video PES data or video depth descriptor PBS data. In the latter case, optionally the segments are then synchronised with video PES data using respective PTSs in the video PES and video depth descriptor PES data in a corresponding manner to that described previously for the encoder.

In an embodiment of the 3D video image decoding apparatus 200, it also comprises an OSD generation means or an OSD generator 220, operable to generate a 3D on screen display for superposition on a 3D video image, wherein the apparent distance of the 3D on screen display is less than or equal to the overall minimum apparent distance to an observer for the current segment. As described herein, this is achieved by using a disparity for the OSD that equals or exceeds the overall minimum distance disparity for the current segment, or where sub-regions of images each have overall minimum apparent distance values, a disparity that exceeds the shortest overall minimum apparent distance among the sub-regions that the OSD overlaps.

In an embodiment of the 3D video image decoding apparatus 200, the metadata parsing means is also operable to decode from the metadata associated with a first segment the value or values corresponding to the overall minimum apparent distance for an immediately subsequent segment. Consequently, the OSD generation means 220 is operable to generate a 3D on screen display for superposition on a 3D video image, wherein the apparent distance of the 3D on screen display is less than or equal to the overall minimum apparent distance to an observer for the immediately subsequent segment. As described herein, this is achieved by using a disparity for the OSD that equals or exceeds the overall minimum distance disparity for the immediately subsequent segment as found in the metadata for the current segment, or as per above a disparity based upon the sub-regions that the OSD overlaps. As noted above, the start and end points of segments may be synchronised with presentation time stamps or other time stamps associated with the video (e.g. in the video PES data), and optionally any threshold time period may also be similarly synchronised. However in an alternative embodiment there is no such synchronisation.

An embodiment of the 3D video image decoding apparatus 200 also comprises a distance selection means or distance selector 230 operable to select between the overall minimum apparent distance associated with the current segment and the overall minimum apparent distance associated with the immediately subsequent segment, responsive to an indication of the time until the immediately subsequent segment begins. As described herein, the time indication may be calculated from the current segment length and current progress through that segment, or may be based on an indication of the time to a segment boundary within the metadata, and/or may be indicated by a flag. Also as described herein, the selection may be based on whether an OSD is instigated before or after a threshold time prior to a segment boundary, and this threshold can be specific to an OSD function.

It will be appreciated that the 3D video image decoding apparatus 200 can be incorporated into any device generating a 3D display and onscreen displays, including 3D televisions with OSDs for TV controls and other menus, 3D broadcast and webcast (IPTV) receivers, either separate to or integrated within TVs, with OSDs for electronic program guides and the like, playback systems for playing back 3D video on physical media, again having OSDs for chapter selections or similar and other menus or data, games consoles such as the Sony® Playstation 3®, with OSDs such as the so-called cross media bar and other menus or data, and digital cinemas receiving digitally distributed films incorporating subtitles and the like.

More generally, as noted previously it will be understood that such devices may provide as OSDs current programme details, electronic program guides, clocks, subtitles or closed captions, or a menu. Similarly, OSD information may be for information distributed concurrently with 3D video (e.g subtitling), information retrieved synchronously from a different network (e.g subtitles via internet) or other information received, generated or stored at the receiver. Alternatively or in addition the information presented by an OSD may not be directly related to the event or service, or the operation of the receiver; for example being a 3D display of email notifications, instant messages and/or interactions with social networks.

It will be appreciated that receivers/transmitters and/or devices on the receiver or transmitter sides of the system described herein may comply with 3D broadcasting or distributions standards from the DVB Project, ETSI, ATSC, SMPTE, CEA or other standards bodies, or national or regional profiles of any such standards.

It will be appreciated that whilst the above description refers to overall minimum apparent distance to an observer and to the overall minimum distance disparity within a segment, alternatives may be considered. For example, in a 3D video segment lasting 3 minutes, there may be a half-second event, such as an explosion, in which debris is shown to reach as close to the observer as the system allows. It would be undesirable for the OSD to be set at this short apparent distance for the rest of the segment, and so in embodiments of the present invention strategies may be adopted to discount statistical outliers of this kind. For example, the overall minimum apparent distance to an observer may be defined in terms of standard deviation(s) from the average minimum apparent distance to the observer over the stereoscopic images of the segment; for example it may be one or two standard deviations from the average, or a fractional deviation; a suitable value may be empirically determined. Similarly the overall minimum apparent distance to an observer may be defined as the average of the N closest minimum apparent distances of the stereoscopic images of the segment; for example N=36 would provide an average amounting to 1.5 seconds of images at a 24 frame image rate. Again N could be empirically determined.

Finally it will be appreciated that a 3D video may be for example received for retransmission and hence already comprise segments and some metadata structure associated with them. In this case, the 3D video image encoding apparatus and the corresponding method below do not require a segmentation means or step of their own.

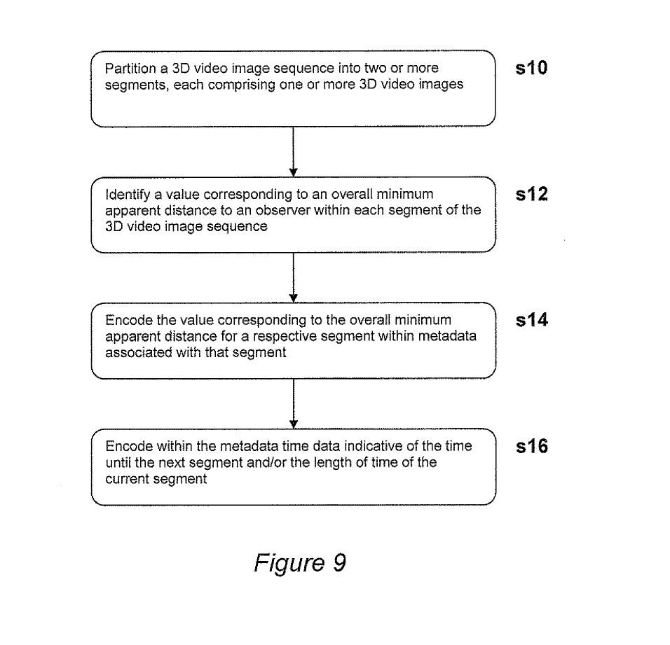

Referring now to FIG. 9, a method of 3D video image encoding comprises: in a first step s10, partitioning a 3D video image sequence into two or more segments, each comprising one or more 3D video images;

in a second step s12, identifying a value corresponding to an overall minimum apparent distance to an observer within each segment of the 3D video image sequence;

in a third step s14, encoding the value corresponding to the overall minimum apparent distance for a respective segment within metadata associated with that segment; and

in a fourth step s16, encoding within the metadata time data indicative of the time until the next segment and/or the length of time of the current segment.

It will be apparent to a person skilled in the art that variations in the above method corresponding to operation of the various embodiments of the apparatus as described and claimed herein are considered within the scope of the present invention, including but not limited to:
i. in a further step, encoding within metadata associated with a first segment the value corresponding to the overall minimum apparent distance for an immediately subsequent segment;
ii. the value corresponding to the overall minimum apparent distance for a segment being a disparity between corresponding image elements of a left and right image of a 3D video image pair;
   or for each of a plurality of sub-regions of a 3D video image, the plurality of values corresponding to the overall minimum apparent distance for each of the sub-regions in images of a segment being a disparity between corresponding image elements of sub-regions of a left and right image of a 3D video image pair; and
iii. the metadata being one or more selected from the list consisting of PMT,

Video PES and video depth descriptor PES, and in the latter case synchronising the segments identified in the metadata using corresponding PTSs in each of the video PES and video depth descriptor PES data.

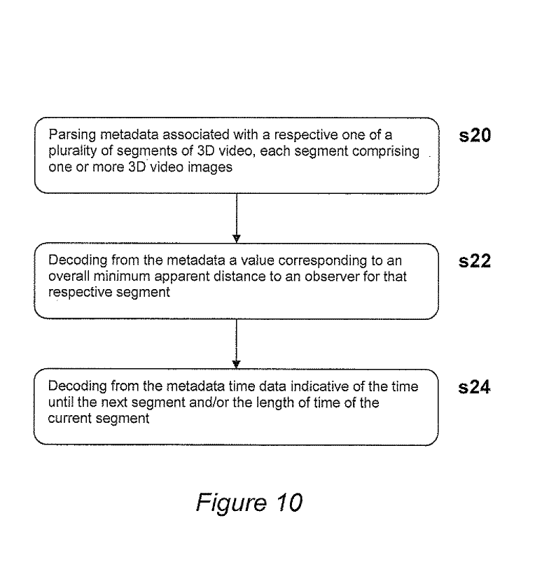

Referring now to FIG. 10, a method of 3D video image decoding comprises: in a first step s20, parsing metadata associated with a respective one of a plurality of segments of 3D video, each segment comprising one or more 3D video images;

in a second step s22, decoding from the metadata a value corresponding to an overall minimum apparent distance to an observer for that respective segment; and

in a third step s24, decoding from the metadata time data indicative of the time until the next segment and/or the length of time of the current segment.

It will be apparent to a person skilled in the art that variations in the above method corresponding to operation of the various embodiments of the apparatus as described and claimed herein are considered within the scope of the present invention, including but not limited to:
i. generating a 3D on screen display for superposition on a 3D video image, wherein the apparent distance of the 3D on screen display is less than or equal to the overall minimum apparent distance to an observer for the current segment;
ii. decoding from the metadata associated with a first segment the value corresponding to the overall minimum apparent distance for an immediately subsequent segment;
   where the metadata may be one or more selected from the list consisting of PMT, Video PES and video depth descriptor PBS, and in the latter case synchronising the segments identified in the metadata using corresponding PTSs in each of the video PBS and video depth descriptor PBS data;
iii. dependent upon ii. above, selecting between the overall minimum apparent distance associated with the current segment and the overall minimum apparent distance associated with the immediately subsequent segment, responsive to an indication of the time until the immediately subsequent segment begins; and
iv. decoding a plurality of values for a plurality of sub-regions of images in the segment.

Finally, it will be appreciated that the methods disclosed herein may be carried out on conventional hardware suitably adapted as applicable by software instruction or by the inclusion or substitution of dedicated hardware. For example, the functions of partitioning a 3D video into segments, analysing the images thereof to obtain a value corresponding to an overall minimum apparent distance to an observer within a segment, and encoding the value and time data within metadata associated with the segment may be carried out by any suitable hardware, software or a combination of the two. In particular, a processor operating under suitable instruction may carry out the role of any or all of the segmenter 110, image processor 120, and metadata generator 130 in the encoder, or similarly the metadata parser 210, OSD generator 220, and distance selector 230 in the decoder.

Thus the required adaptation to existing parts of a conventional equivalent device may be implemented in the form of a computer program product or similar object of manufacture comprising processor implementable instructions stored on a data carrier such as a floppy disk, optical disk, hard disk, PROM, RAM, flash memory or any combination of these or other storage media, or transmitted via data signals on a network such as an Ethernet, a wireless network, the Internet, or any combination of these of other networks, or realised in hardware as an ASIC (application specific integrated circuit) or an FPGA (field programmable gate array) or other configurable circuit suitable to use in adapting the conventional equivalent device.

1-33. (canceled)

34. A 3D video image encoding apparatus, comprising:
segmentation circuitry configured to partition a 3D video image sequence into two or more segments, each comprising one or more 3D video images;
image processing circuitry configured operable to identify a value corresponding to an overall minimum apparent distance to an observer within each segment of the 3D video image sequence;
metadata generation circuitry configured to encode the value corresponding to the overall minimum apparent distance for a respective segment within metadata associated with that segment; and wherein
the metadata circuitry is configured to encode within the metadata an indication of the length of time of the segment or an indication of the time until the next segment.

35. The 3D video image encoding apparatus according to claim 34, in which the metadata generation circuitry is configured to encode within metadata associated with a first segment the value corresponding to the overall minimum apparent distance for an immediately subsequent segment.

36. The 3D video image encoding apparatus according to claim 34, in which the value corresponding to the overall minimum apparent distance for a segment is a disparity between corresponding image elements of a left and right image of a 3D video image pair.

37. The 3D video image encoding apparatus according to claim 34, in which the apparatus is configured to encode a value corresponding to the overall minimum apparent distance in metadata associated with a video depth descriptor packetized elementary stream; and in which
the apparatus is configured to synchronize the segments identified in the video depth descriptor packetized elementary stream with a video packetized elementary stream, based upon corresponding presentation time stamps in each stream.

38. The 3D video image encoding apparatus according to claim 34, in which the apparatus is configured to identify and encode a plurality of values corresponding to the overall minimum apparent distance for each of a plurality of corresponding sub-regions of 3D video images in the segment.

39. A 3D video image decoding apparatus, comprising:
metadata parsing circuitry configured to parse metadata associated with a respective one of a plurality of segments of 3D video, each segment comprising one or more 3D video images, the metadata parsing circuitry configured to decode from the metadata a value corresponding to an overall minimum apparent distance to an observer for that respective segment; and wherein
the metadata parsing circuitry is configured to decode from the metadata an indication of the length of time of that segment.

40. The 3D video image decoding apparatus, comprising:
metadata parsing circuitry configured to parse metadata associated with a respective one of a plurality of segments of 3D video, each segment comprising one or more 3D video images, the metadata parsing circuitry configured operable to decode from the metadata a value corresponding to an overall minimum apparent distance to an observer for that respective segment; and wherein
the metadata parsing circuitry is configured to decode from the metadata an indication of the time until a next segment.

41. The 3D video image decoding apparatus according to claim 40, further comprising:
an onscreen display generator circuitry configured to generate a 3D on screen display for superposition on a 3D video image, wherein the apparent distance of the 3D on screen display is less than or equal to the overall minimum apparent distance to an observer for the current segment.

42. The 3D video image decoding apparatus according to claim 40, in which the metadata parsing circuitry is configured to decode from the metadata associated with a first segment the value corresponding to the overall minimum apparent distance for an immediately subsequent segment.

43. The 3D video image decoding apparatus according to claim 42, further comprising:
an onscreen display generator circuitry configured to generate a 3D on screen display for superposition on a 3D video image, wherein the apparent distance of the 3D on screen display is less than or equal to the overall minimum apparent distance to an observer for the immediately subsequent segment.

44. The 3D video image decoding apparatus according to claim 43, further comprising:
distance selection circuitry configured to select between the overall minimum apparent distance associated with the current segment and the overall minimum apparent distance associated with the immediately subsequent segment responsive to an indication of the time until the immediately subsequent segment begins.

45. The 3D video image decoding apparatus according to claim 40, in which the metadata parsing circuitry is configured to parse metadata from a video depth descriptor packetized elementary stream data; and in which
the apparatus is configured to synchronize the segments identified in the video depth descriptor packetized elementary stream with a video packetized elementary stream using corresponding presentation time stamps in each stream.

46. The 3D video image decoding apparatus according to claim 40, in which the metadata parsing circuitry is configured to decode from the metadata a plurality of values corresponding to the overall minimum apparent distance for each of a plurality of corresponding sub-regions of 3D video images in the segment.

47. A method of 3D video image encoding, comprising:
partitioning a 3D video image sequence into two or more segments, each comprising one or more 3D video images;
identifying a value corresponding to an overall minimum apparent distance to an observer within each segment of the 3D video image sequence;
encoding the value corresponding to the overall minimum apparent distance for a respective segment within metadata associated with that segment; and
encoding by circuitry within the metadata an indication of the length of time of the segment or an indication of the time until the next segment.

48. The method according to claim 47, further comprising encoding by circuitry within metadata associated with a first segment the value corresponding to the overall minimum apparent distance for an immediately subsequent segment.

49. The method according to claim 48, in which the metadata is a video depth descriptor packetized elementary stream, and the method further comprises:
synchronizing the segments identified in the video depth descriptor packetized elementary stream with a video packetized elementary stream, based upon corresponding presentation time stamps in each stream.

50. A method of 3D video image decoding, comprising:
parsing metadata associated with a respective one of a plurality of segments of 3D video, each segment comprising one or more 3D video images;
decoding from the metadata a value corresponding to an overall minimum apparent distance to an observer for that respective segment; and
decoding by circuitry from the metadata an indication of the length of time of that segment or an indication of the time until a next segment.

51. The method according to claim 50, further comprising generating a 3D on screen display for superposition on a 3D video image, wherein the apparent distance of the 3D on screen display is less than or equal to the overall minimum apparent distance to an observer for the current segment.

52. The method according to claim 50, further comprising decoding from the metadata associated with a first segment the value corresponding to the overall minimum apparent distance for an immediately subsequent segment.

53. The method according to claim 52, in which the metadata is a video depth descriptor packetized elementary stream data, and the method further comprises:
synchronizing by circuitry the segments identified in the video depth descriptor packetized elementary stream with a video packetized elementary stream, based upon corresponding presentation time stamps in each stream.

54. The method according to claim 52, further comprising selecting between the overall minimum apparent distance associated with the current segment and the overall minimum apparent distance associated with the immediately subsequent segment, responsive to an indication of the time until the immediately subsequent segment begins.
